(19) United States
(12) Patent Application Publication
(10) Pub. No.: US 2025/0234423 A1
(43) Pub. Date: Jul. 17, 2025

(54) METHOD AND DEVICE FOR DEPRIORITIZATION EFFECT OF UPLINK DRX TIMER

(71) Applicant: Samsung Electronics Co., Ltd., Suwon-si, Gyeonggi-do (KR)

(72) Inventors: Sangkyu BAEK, Suwon-si (KR); Anil AGIWAL, Suwon-si (KR); Jaehyuk JANG, Suwon-si (KR)

(21) Appl. No.: 18/848,738

(22) PCT Filed: Apr. 20, 2023
(86) PCT No.: PCT/KR2023/005343

§ 371 Date: Sep. 19, 2024

(30) Foreign Application Priority Data
Apr. 25, 2022 (KR) 10-2022-0050643

(51) Int. Cl. H04W 76/28; H04L 1/1812; H04W 72/115; H04W 72/21

(52) U.S. Cl. CPC H04W 76/28; H04L 1/1812; H04W 72/115; H04W 72/21

(57) ABSTRACT

The present disclosure relates to a 5G or 6G communication system for supporting higher data transmission rates. Disclosed are a method and device for controlling the operation of a timer when deprioritized transmission occurs in a terminal operating in a DRX mode.

### TECHNICAL FIELD

The present invention relates to a technology for controlling driving of a timer when deprioritized transmission occurs in a terminal operating in DRX.

### BACKGROUND ART

5-th generation (5G) mobile communication technologies define broad frequency bands such that high transmission rates and new services are possible, and may be implemented not only in “Sub 6 GHz” bands, such as 3.5 GHZ, but also in “Above 6 GHz” bands referred to as mm Wave including 28 GHz and 39 GHz. In addition, it has been considered to implement 6-th generation (6G) mobile communication technologies referred to as Beyond 5G systems in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra-reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting various numerologies (e.g., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information on locations and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) that is UE-satellite direct communication for providing coverage in an area in which communication with terrestrial networks is unavailable, and positioning.

In addition, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service field regarding a 5G baseline architecture (e.g., service based architecture or service based interface) for combining Network Functions Virtualization (NFV) and Software-Defined Networking (SDN) technologies, and Mobile Edge Computing (MEC) for receiving services based on user equipment (UE) locations.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting augmented reality (AR), virtual reality (VR), mixed reality (MR), and the like, 5G performance improvement and complexity reduction by utilizing artificial intelligence (AI) and machine learning (ML), AI service support, metaverse service support, and drone communication.

Also, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas, and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

Meanwhile, as a method for reducing excessive power consumption of a terminal, a discontinuous reception (DRX) technology may be applied. A terminal operating in DRX may not monitor a physical downlink control channel (PDCCH) in a time other that an active time, thereby reducing power consumption. The active time may be defined by various timers, for example, by the expiration of a drx-HARQ-RTT-TimerUL or by a drx-Retransmission TimerUL.

### DISCLOSURE OF INVENTION

### Technical Problem

A drx-RetransmissionTimerUL that drives after the expiration of a drx-HARQ-RTT-TimerUL may extend an active time so that a time in which an uplink retransmission resource is allocated is not extended to the next active time. However, in a case, the active time may be unnecessarily extended. In this case, for example, when a retransmission resource is allocated for deprioritized transmission, it may be needed to control driving of the drx-RetransmissionTimerUL so that the active time may not be unnecessarily extended.

### Solution to Problem

A method performed by a terminal in a wireless communication system according to an embodiment of the disclosure to solve the aforementioned issues may include: performing a discontinuous reception (DRX) operation; identifying an uplink grant for transmission; identifying that the uplink grant is deprioritized, based on logical channel-based prioritization being configured; and starting a hybrid automatic repeat request (HARQ) round-trip time (RTT) timer associated with to the DRX operation in a first symbol after end of a physical uplink shared channel (PUSCH) resource corresponding to the uplink grant, based on the uplink grant being de-prioritized.

Also, a terminal in a wireless communication system according to an embodiment of the disclosure may include: a transceiver; and a controller configured to perform a discontinuous reception (DRX) operation, identify an uplink grant for transmission, identify that the uplink grant is deprioritized, based on logical channel-based prioritization being configured, and start a hybrid automatic repeat request (HARQ) round-trip time (RTT) timer associated with to the DRX operation in a first symbol after end of a physical uplink shared channel (PUSCH) resource corresponding to the uplink grant, based on the uplink grant being de-prioritized.

### Advantageous Effects of Invention

According to the disclosure, when a DRX operation is applied to a terminal, even in a case of resource reallocation for deprioritized transmission, an active time may be controlled not to be unnecessarily extended, thereby reducing unnecessary power consumption. In addition, when the DRX operation is applied to the terminal, the active time may be controlled to be extended for resource reallocation for deprioritized transmission when the deprioritized transmission occurs, thereby reducing data transmission delay time.

### BRIEF DESCRIPTION OF DRAWINGS

FIG. 1 is a diagram illustrating the operating mode of URLLC communication in a mobile communication system according to an embodiment of the disclosure.

FIG. 2 is a diagram illustrating the operating mode of a DRX timer according to the deprioritization of a CG in an embodiment of the disclosure.

FIG. 3 is a diagram illustrating the operating mode of a DRX timer according to the deprioritization of a CG in an embodiment of the disclosure.

FIG. 4 is a flowchart illustrating the operating mode of a DRX timer according to the deprioritization of a CG in an embodiment of the disclosure.

FIG. 5 is a flowchart illustrating the operating mode of a DRX timer according to the deprioritization of a CG in an embodiment of the disclosure.

FIG. 6 is a flowchart illustrating the operating mode of a DRX timer according to the deprioritization of a CG in an embodiment of the disclosure.

FIG. 7 is a flowchart illustrating the operating mode of a DRX timer according to the deprioritization of a CG in an embodiment of the disclosure.

FIG. 8 is a diagram illustrating the operating mode of a DRX timer according to the deprioritization of a DG in an embodiment of the disclosure.

FIG. 9 is a flowchart illustrating the operating mode of a DRX timer according to the deprioritization of a DG in an embodiment of the disclosure.

FIG. 10 is a flowchart illustrating the operating mode of a DRX timer according to the deprioritization of a DG in an embodiment of the disclosure.

FIG. 11 is a flowchart illustrating the operating mode of a DRX timer according to the deprioritization of a DG in an embodiment of the disclosure.

FIG. 12 is a diagram illustrating the structure of a base station according to an embodiment of the present invention.

FIG. 13 is a diagram illustrating the structure of a terminal according to an embodiment of the present invention.

### MODE FOR THE INVENTION

Hereinafter, when a detailed description of related known configurations or functions is determined to make the gist of the present invention unnecessarily unclear in describing the present invention, the detailed description will be omitted herein. Hereinafter, embodiments of the present invention will be described with reference to the accompanying drawings.

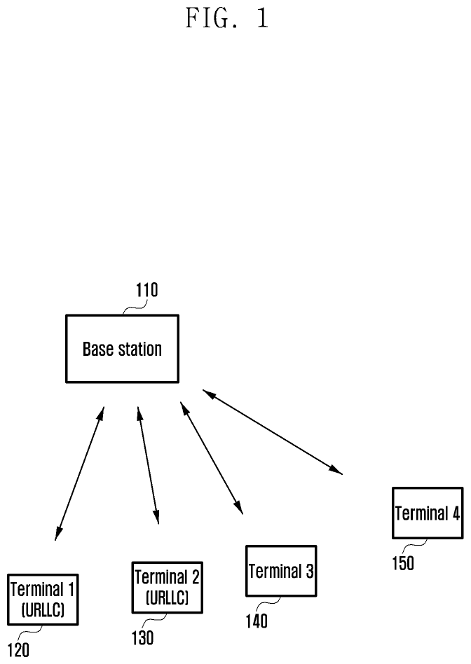

FIG. 1 is a diagram illustrating the operating mode of URLLC communication in a mobile communication system according to an embodiment of the disclosure.

In the mobile communication system, a base station 110 may be wirelessly connected with a plurality of terminals 120, 130, 140, and 150 to provide communication services for the terminals. The communication services may include enhanced mobile broadband (EMBB) services, which are high-speed data communication services using a broadband, ultra-reliable and low-latency communication (URLLC) services requiring high transmission stability and a low delay, or massive machine-type communication (MMTC) used by a sensor network rather than a user device. The URLLC services may be services requiring the highest service qualities, such as a transmission stability of up to 99.999999% and an end-to-end delay time of 0.5 ms or less, in a wireless network for factory automation, virtual reality (VR), augmented reality (AR), and the like.

Within a single base station, a terminal requiring URLLC (URLLC terminal) may coexist with a terminal not requiring URLLC (EMBB terminal or MMTC terminal). The base station needs to perform radio resource scheduling to meet requirements of the terminal requiring URLLC. In the embodiment of FIG. 1, it is assumed that terminal 1 120 and terminal 2 130 are URLLC terminals, and terminal 3 140 and terminal 4 150 are terminals not requiring URLLC.

The URLLC services may have different service quality requirements depending on characteristics of the services. For example, a URLLC service may require high transmission stability but have a relatively less strict requirement in delay time. However, a URLLC service may require general transmission stability but have a requirement of a very short delay time. Various URLLC services may occur simultaneously within a terminal, and due to the diversity of URLLC service requirements, the traditional scheduling method of allocating transmission resources per terminal and sharing the resources among data of a plurality of services may reduce the efficiency of radio resources. Therefore, dedicated radio resources for each URLLC service may be allocated to meet the requirements of the URLLC service. In this case, radio resources for various services including not only a URLLC service but also an EMBB service may be configured simultaneously, and the configured radio resources may overlap on the time axis (or time and frequency axes). The terminal may need to select and transmit one radio resource due to limited capabilities of the terminal. A method of selecting a radio resource to be transmitted is referred to as logical channel (LCH)-based prioritization.

According to a logical channel-based prioritization operation, a radio resource with the highest priority is transmitted, and the other radio resources are deprioritized and not transmitted. Deprioritization may be achieved before transmission using a corresponding radio resource, but may also be performed by deprioritizing the transmission using the radio resource, which has already started, by another radio resource and canceling the transmission. In logical channel-based prioritization, the priorities of uplink radio resources (uplink grants) of a dynamic grant and a configured grant may be determined depending on whether a medium access control (MAC) protocol data unit (PDU) to be transmitted via the uplink radio resources has been generated. For example, when a MAC PDU is generated and stored in a hybrid automatic repeat request (HARQ) buffer, the highest priority among the priorities of logical channels corresponding to data included in the MAC PDU may become the priority of an uplink radio resource. However, for example, when no MAC PDU is generated and stored in the HARQ buffer, data may be transmitted using an uplink radio resource, and thus the highest priority among the priorities of logical channels that may be included in a MAC PDU and have transmittable data may become the priority of an uplink radio resource. The priority of a scheduling request (SR) may be determined based on the priority of a logical channel that has triggered the scheduling request.

Even for a URLLC terminal receiving URLLC services, excessive power consumption may reduce the usability of the terminal, and thus discontinuous reception (DRX), which is a method for reducing power consumption of a terminal, may be applied. DRX allows a terminal not to monitor a physical downlink control channel (PDCCH) that allocates radio resources or transmits control information during a time other than an active time, thereby reducing the power consumption of the terminal. The active time of the terminal may be defined as a time in which at least one of a drx-onDurationTimer, a drx-InactivityTimer, a drx-RetransmissionTimerDL, a drx-RetransmissionTimerUL, a ra-ContentionResolutionTimer, and a msgB-Response Window timers drives. The drx-RetransmissionTimerUL is a timer that starts after a drx-HARQ-RTT-TimerUL, which starts after transmitting an uplink radio resource (uplink grant), expires, and refers to a time when a retransmission resource with respect to the initial transmission of the uplink radio resource may be allocated. Therefore, a time when the drx-RetransmissionTimerUL drives is necessary for the retransmission of an uplink radio resource. Otherwise, a time when a resource for the retransmission of an uplink radio resource is allocated is delayed until the next active time, thus increasing the transmission delay time of data and causing a deterioration in the quality of URLLC service.

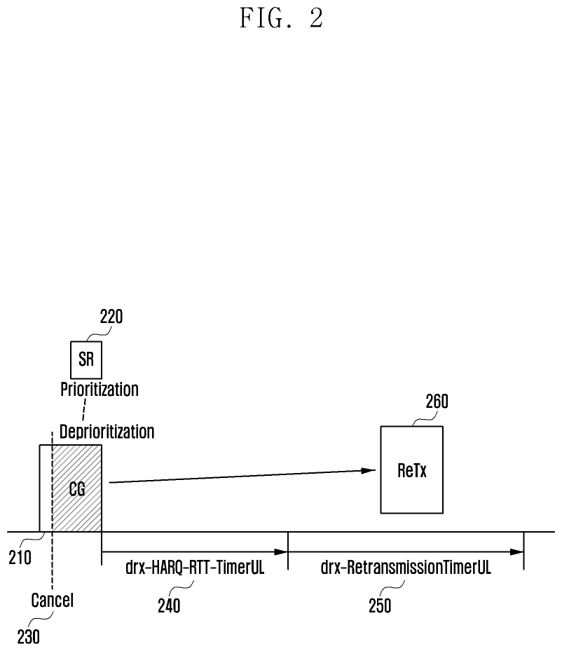

FIG. 2 is a diagram illustrating the operating mode of a DRX timer according to the deprioritization of a CG in an embodiment of the disclosure.

A configured grant (CG) is an uplink radio resource configured at regular intervals, and an activated CG is repeatedly allocated with the same size of radio resources without resource allocation using a separate PDCCH. The embodiment of FIG. 2 illustrates a case in which a CG 210 is initially transmitted as a prioritized radio resource (prioritized uplink grant), but a high-priority scheduling request 220 subsequently occurs, and thus a scheduling request message is prioritized and the CG resource is deprioritized. In another embodiment, the CG resource may be deprioritized not only by the scheduling request but also by a DG resource or another CG resource overlapping on the time axis. Here, the transmission of the CG, which has already started, may be canceled due to the deprioritization of the CG (230).

Since a base station is able to identify that the transmission of the CG has started, the base station may allocate a retransmission resource for transmitting a MAC PDU of the CG that has been deprioritized and not transmitted to a terminal. In a case of a terminal in which DRX is configured, since the allocation of the retransmission resource is possible in the active time of the terminal, the extension of the active time may be required for the allocation of the retransmission resource. To this end, when the transmission of the CG is deprioritized and canceled by another radio resource (SR, DG, or another CG) before the transmission of the CG ends, that is, when the MAC PDU is partially transmitted, a MAC device of the terminal may start a drx-HARQ-RTT-TimerUL of a corresponding HARQ process in a first symbol after the end of a physical uplink shared channel (PUSCH) resource for the transmission of the CG (240). When the transmission of the CG is a bundle transmission in which the same resource is transmitted in a plurality of CGs, the drx-HARQ-RTT-TimerUL of the HARQ process may be started in a first symbol after the end of a PUSCH resource for first transmission of the bundle. The embodiment of FIG. 2 shows that the drx-HARQ-RTT-TimerUL is started in the first symbol after the end of the PUSCH resource for the transmission of the CG regardless of whether the transmission of the CG is completed.

A drx-RetransmissionTimerUL of the HARQ process may be stopped in the first symbol after the end of the PUSCH resource for the transmission of the CG. When the transmission of the CG is the bundle transmission in which the same resource is transmitted in the plurality of CGs, the drx-RetransmissionTimerUL of the HARQ process may be stopped in the first symbol after the end of the PUSCH resource for the first transmission of the bundle. When driving the drx-RetransmissionTimerUL is stopped, the active time of the terminal may be prevented from being unnecessarily extended, thereby reducing the power consumption of the terminal.

The embodiment of FIG. 2 shows that the drx-RetransmissionTimerUL is stopped in the first symbol after the end of the PUSCH resource for the transmission of the CG regardless of whether the transmission of the CG is completed. However, in another embodiment, a time point at which the drx-RetransmissionTimerUL stops driving may be a time point at which a first PUSCH for the CG is transmitted.

Subsequently, the MAC device of the terminal may start the drx-RetransmissionTimerUL at a time point at which the drx-HARQ-RTT-TimerUL stops driving or expires (250). A time when the drx-RetransmissionTimerUL drives may become the active time, and in the active time, the terminal may perform PDCCH monitoring, and the base station may allocate the retransmission resource for the transmission of the CG previously deprioritized and not transmitted to the terminal (260). Specifically, the base station may estimate the operating time of the drx-RetransmissionTimerUL of the terminal, and may allocate a radio resource to the terminal through a PDCCH at the time.

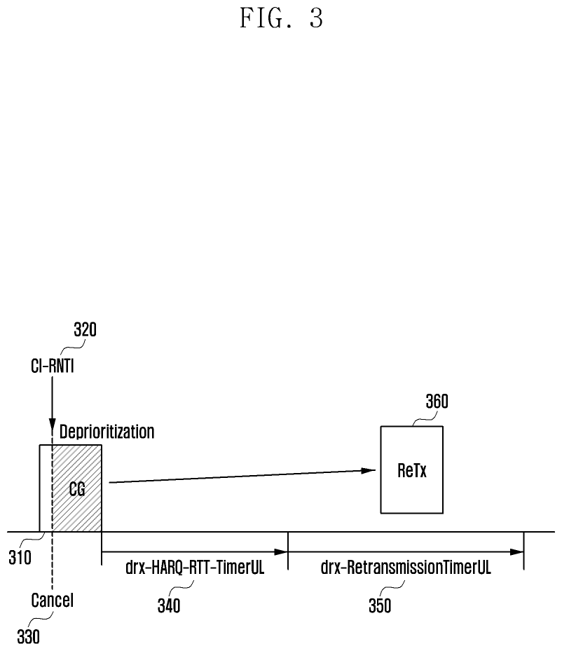

FIG. 3 is a diagram illustrating the operating mode of a DRX timer according to the deprioritization of a CG in an embodiment of the disclosure.

A configured grant (CG) is an uplink radio resource configured at regular intervals, and an activated CG is repeatedly allocated with the same size of radio resources without resource allocation using a separate PDCCH. In the embodiment of FIG. 3, a CG 310 is initially transmitted as a prioritized radio resource, but a cancellation indication-radio network temporary identifier (CI-RNTI) 320 is subsequently received from a base station, and thus the transmission of the CG may be canceled. When the transmission of the CG is canceled by the CI-RNTI, the CG may be deprioritized and changed to a deprioritized uplink radio resource. The transmission of the CG, which has already started, may be canceled due to the deprioritization of the CG (330).

Since the base station is able to identify that the transmission of the CG has started, the base station may allocate a retransmission resource for transmitting a MAC PDU of the CG that has been deprioritized and not transmitted to a terminal. In a case of a terminal in which DRX is configured, since the allocation of the retransmission resource is possible in the active time of the terminal, the extension of the active time may be required for the allocation of the retransmission resource. To this end, when the transmission of the CG is deprioritized and canceled by the CN-RNTI before the transmission of the CG ends, that is, when the MAC PDU is partially transmitted, a MAC device of the terminal may start driving a drx-HARQ-RTT-TimerUL of a corresponding HARQ process in a first symbol after the end of a PUSCH resource for the transmission of the CG (340). When the transmission of the CG is a bundle transmission in which the same resource is transmitted in a plurality of CGs, driving the drx-HARQ-RTT-TimerUL of the HARQ process may be started in a first symbol after the end of a PUSCH resource for first transmission of the bundle. The embodiment of FIG. 3 shows that driving the drx-HARQ-RTT-TimerUL is started in the first symbol after the end of the PUSCH resource for the transmission of the CG regardless of whether the transmission of the CG is completed.

A drx-RetransmissionTimerUL of the HARQ process may be stopped in the first symbol after the end of the PUSCH resource for the transmission of the CG. When the transmission of the CG is the bundle transmission in which the same resource is transmitted in the plurality of CGs, the drx-RetransmissionTimerUL of the HARQ process may be stopped in the first symbol after the end of the PUSCH resource for the first transmission of the bundle. When the operation of the drx-RetransmissionTimerUL is stopped, the active time of the terminal may be prevented from being unnecessarily extended, thereby reducing the power consumption of the terminal.

The embodiment of FIG. 3 shows that the drx-RetransmissionTimerUL is stopped in the first symbol after the end of the PUSCH resource for the transmission of the CG regardless of whether the transmission of the CG is completed. However, in another embodiment, a time point at which the drx-RetransmissionTimerUL stops operating may be a point at which a first PUSCH for the CG is transmitted.

Subsequently, the MAC device of the terminal may start the drx-RetransmissionTimerUL at a time point at which the drx-HARQ-RTT-TimerUL stops or expires (250). A time when the drx-RetransmissionTimerUL drives may become the active time, and in the active time, the terminal may perform PDCCH monitoring, and the base station may allocate the retransmission resource for the transmission of the CG previously deprioritized and not transmitted to the terminal (360). The base station may estimate the operating time of the drx-Retransmission TimerUL of the terminal, and may allocate a radio resource to the terminal through a PDCCH at the time.

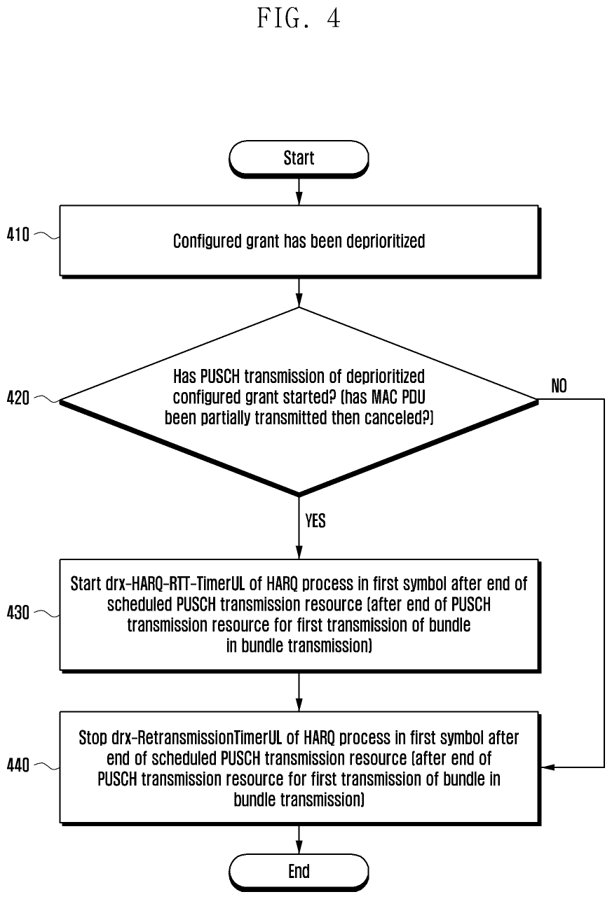

FIG. 4 is a flowchart illustrating the operating mode of a DRX timer according to the deprioritization of a CG in an embodiment of the disclosure.

The embodiment of FIG. 4 illustrates an example in which a CG is deprioritized. With reference to FIG. 4, a CG may be deprioritized (410).

Here, it may be identified whether the PUSCH transmission of the deprioritized CG has started (420). The PUSCH transmission of the CG having started may mean that a MAC PDU transmitted via the CG has been partially transmitted but canceled due to the deprioritization.

If the PUSCH transmission of the deprioritized CG has already started (the MAC PDU has been partially transmitted and then canceled), a drx-HARQ-RTT-TimerUL of a corresponding HARQ process may be started in a first symbol after the end of a scheduled PUSCH transmission resource (after the end of a PUSCH transmission resource for first transmission of a bundle in bundle transmission) (430). Operation 430 shows that the transmission of the CG is not completed, but the drx-HARQ-RTT-TimerUL is started in the first symbol after the end of the PUSCH resource for the transmission of the CG regardless of whether the transmission of the CG is completed. Starting the drx-HARQ-RTT-TimerUL may be for starting a drx-RetransmissionTimerUL after the expiration of this timer to allocate a retransmission resource for the CG deprioritized and not be transmitted. In addition, driving the drx-RetransmissionTimerUL of the HARQ process may be stopped in the first symbol after the end of the scheduled PUSCH transmission resource (after the end of the PUSCH transmission resource for the first transmission of the bundle in the bundle transmission) (440), which may be for preventing the power consumption of the terminal due to the unnecessary extension of the active time.

If the PUSCH transmission of the deprioritized CG has not already started in operation 420, which is not a case where the MAC PDU is partially transmitted and then canceled, the drx-RetransmissionTimerUL driving in the HARQ process may be stopped in the first symbol after the end of the scheduled PUSCH transmission resource (after the end of the PUSCH transmission resource for the first transmission of the bundle in the bundle transmission) instead of starting the drx-HARQ-RTT-TimerUL (440).

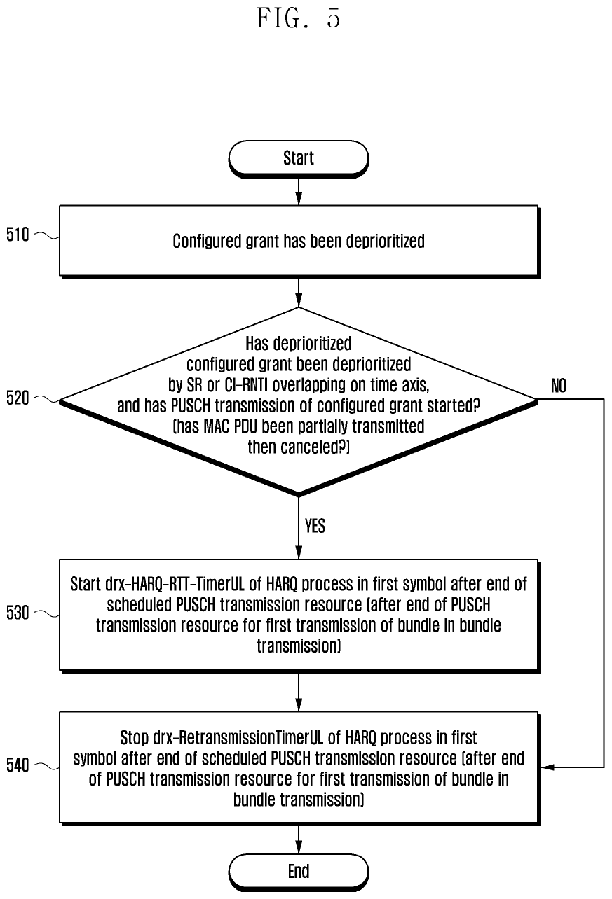

FIG. 5 is a flowchart illustrating the operating mode of a DRX timer according to the deprioritization of a CG in an embodiment of the disclosure.

The embodiment of FIG. 5 illustrates a case in which a CG is deprioritized. With reference to FIG. 5, a CG may be deprioritized (510).

Here, it may be identified a cause by which the deprioritized CG has been deprioritized and whether the PUSCH transmission of the deprioritized CG has already started (520). The PUSCH transmission of the CG having already started may mean that a MAC PDU transmitted via the CG has been partially transmitted but canceled due to the deprioritization.

If the deprioritized CG has been deprioritized by an SR or CI-RNTI overlapping on the time axis and the PUSCH transmission of the CG has already started (the MAC PDU has been partially transmitted and then canceled), a drx-HARQ-RTT-TimerUL of a corresponding HARQ process may be started in a first symbol after the end of a scheduled PUSCH transmission resource (after the end of a PUSCH transmission resource for first transmission of a bundle in bundle transmission) (530). Operation 530 shows that the transmission of the CG is not completed, but the drx-HARQ-RTT-TimerUL is started in the first symbol after the end of the PUSCH resource for the transmission of the CG regardless of whether the transmission of the CG is completed. Starting the drx-HARQ-RTT-TimerUL may be for starting a drx-RetransmissionTimerUL after the expiration of this timer to allocate a retransmission resource for the CG deprioritized and not be transmitted. In addition, the drx-RetransmissionTimerUL of the HARQ process may be stopped in the first symbol after the end of the scheduled PUSCH transmission resource (after the end of the PUSCH transmission resource for the first transmission of the bundle in the bundle transmission) (540), which may be for preventing the power consumption of the terminal due to the unnecessary extension of the active time.

When the deprioritized CG has been deprioritized by the SR or CI-RNTI overlapping on the time axis but the PUSCH transmission of the CG has not already started or the CG has not been deprioritized by the SR or CI-RNTI (has been deprioritized by a DG or another CG) in operation 520, the drx-RetransmissionTimerUL driving in the HARQ process may be stopped in the first symbol after the end of the scheduled PUSCH transmission resource (after the end of the PUSCH transmission resource for the first transmission of the bundle in the bundle transmission) instead of starting the drx-HARQ-RTT-TimerUL (540).

When the CG has been deprioritized by the DG or the other CG, since a drx-HARQ-RTT-TimerUL of an HARQ process for the other prioritized CG or DG may be started by the transmission of the other prioritized CG or DG, and the active time may be subsequently secured, thus not needing to start the drx-HARQ-RTT-TimerUL for the deprioritized CG.

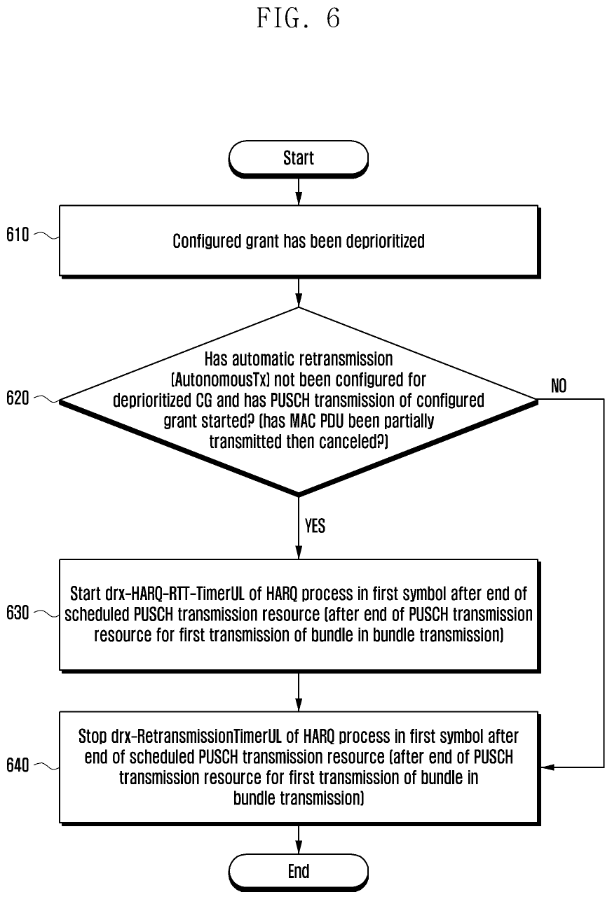

FIG. 6 is a flowchart illustrating the operating mode of a DRX timer according to the deprioritization of a CG in an embodiment of the disclosure.

The embodiment of FIG. 6 illustrates a case in which a CG is deprioritized. With reference to FIG. 6, a CG may be deprioritized (610).

Here, it may be identified whether automatic retransmission (AutonomousTx) is configured for the deprioritized CG and whether the PUSCH transmission of the deprioritized CG has already started (620). Automatic prioritization means an operation of transmitting a MAC PDU via the next available CG resource when the MAC PDU to be transmitted using a CG resource is generated but is deprioritized, and may be configured per CG. When the automatic retransmission of the CG is configured, the utility of CG retransmission by the allocation of a retransmission resource decreases, and thus a need to extend the active time is reduced. In addition, the PUSCH transmission of the CG having already started may mean that a MAC PDU transmitted via the CG has been partially transmitted but canceled due to the deprioritization.

If the automatic retransmission of the deprioritized CG is not configured and the PUSCH transmission of the CG has already started (the MAC PDU has been partially transmitted and then canceled), a drx-HARQ-RTT-TimerUL of a corresponding HARQ process may be started in a first symbol after the end of a scheduled PUSCH transmission resource (after the end of a PUSCH transmission resource for first transmission of a bundle in bundle transmission) (630). Operation 630 shows that the transmission of the CG is not completed, but the drx-HARQ-RTT-TimerUL is started in the first symbol after the end of the PUSCH resource for the transmission of the CG regardless of whether the transmission of the CG is completed. Starting the drx-HARQ-RTT-TimerUL may be for starting a drx-RetransmissionTimerUL after the expiration of this timer to allocate a retransmission resource for the CG deprioritized and not be transmitted. In addition, driving the drx-RetransmissionTimerUL of the HARQ process may be stopped in the first symbol after the end of the scheduled PUSCH transmission resource (after the end of the PUSCH transmission resource for the first transmission of the bundle in the bundle transmission) (640), which may be for preventing the power consumption of the terminal due to the unnecessary extension of the active time.

If the automatic retransmission of the deprioritized CG is not configured but the PUSCH transmission of the CG has not already started or the automatic retransmission of the CG is configured in operation 620, driving the drx-RetransmissionTimerUL of the HARQ process may be stopped in the first symbol after the end of the scheduled PUSCH transmission resource (after the end of the PUSCH transmission resource for the first transmission of the bundle in the bundle transmission) instead of starting the drx-HARQ-RTT-TimerUL (640).

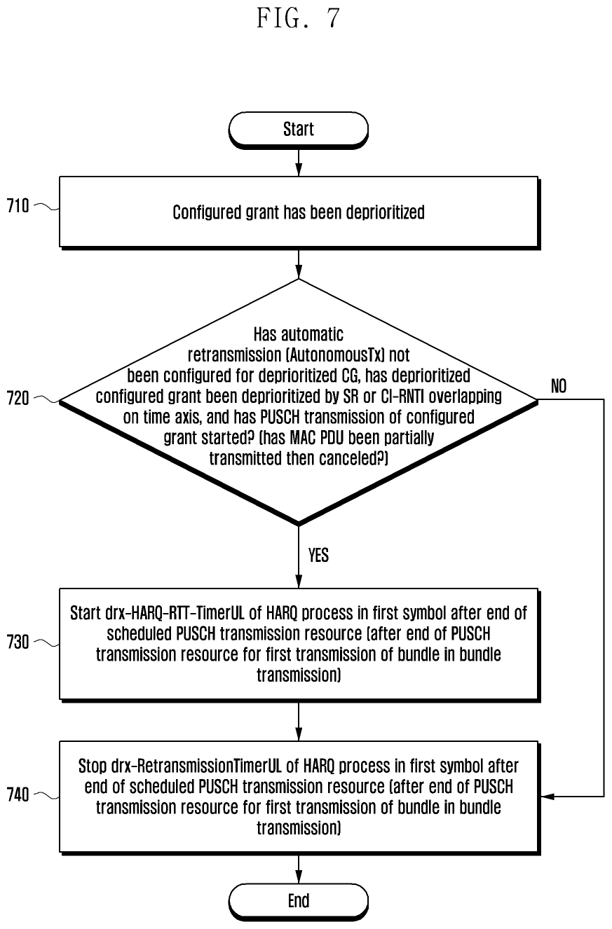

FIG. 7 is a flowchart illustrating the operating mode of a DRX timer according to the deprioritization of a CG in an embodiment of the disclosure.

The embodiment of FIG. 7 illustrates a case in which a CG is deprioritized. With reference to FIG. 7, a CG may be deprioritized (710).

Here, it may be identified whether automatic retransmission (AutonomousTx) is configured for the deprioritized CG, a cause by which the deprioritized CG has been deprioritized, and whether the PUSCH transmission of the deprioritized CG has already started (720). The PUSCH transmission of the CG having already started may mean that a MAC PDU transmitted via the CG has been partially transmitted but canceled due to the deprioritization. As described above, automatic prioritization or automatic retransmission means an operation of transmitting a MAC PDU via the next available CG resource when the MAC PDU to be transmitted using a CG resource is generated but is deprioritized, and may be configured per CG. When the automatic retransmission of the CG is configured, the utility of CG retransmission by the allocation of a retransmission resource decreases, and thus a need to extend the active time is reduced. In addition, the PUSCH transmission of the CG having already started may mean that a MAC PDU transmitted via the CG has been partially transmitted but canceled due to the deprioritization.

When the automatic retransmission of the deprioritized CG is not configured, the deprioritized CG has been deprioritized by an SR or CI-RNTI overlapping on the time axis, and the PUSCH transmission of the CG has already started (the MAC PDU has been partially transmitted and then canceled), a drx-HARQ-RTT-TimerUL of a corresponding HARQ process may be started in a first symbol after the end of a scheduled PUSCH transmission resource (after the end of a PUSCH transmission resource for first transmission of a bundle in bundle transmission) (730). Operation 730 shows that the transmission of the CG is not completed, but the drx-HARQ-RTT-TimerUL is started in the first symbol after the end of the PUSCH resource for the transmission of the CG regardless of whether the transmission of the CG is completed. Starting the drx-HARQ-RTT-TimerUL may be for starting a drx-RetransmissionTimerUL after the expiration of this timer to allocate a retransmission resource for the CG deprioritized and not be transmitted. In addition, the drx-RetransmissionTimerUL of the HARQ process may be stopped in the first symbol after the end of the scheduled PUSCH transmission resource (after the end of the PUSCH transmission resource for the first transmission of the bundle in the bundle transmission) (740), which may be for preventing the power consumption of the terminal due to the unnecessary extension of the active time.

When the automatic retransmission of the deprioritized CG is configured, the deprioritized CG has not been deprioritized by the SR or CI-RNTI overlapping on the time axis, or the PUSCH transmission of the CG has not already started in operation 720, driving the drx-RetransmissionTimerUL of the HARQ process may be stopped in the first symbol after the end of the scheduled PUSCH transmission resource (after the end of the PUSCH transmission resource for the first transmission of the bundle in the bundle transmission) instead of starting the drx-HARQ-RTT-TimerUL (740).

When the CG has been deprioritized by a DG or another CG, since a drx-HARQ-RTT-TimerUL of an HARQ process for the other prioritized CG or DG may be started by the transmission of the other prioritized CG or DG, and the active time may be subsequently secured, thus not needing to start the drx-HARQ-RTT-TimerUL for the deprioritized CG.

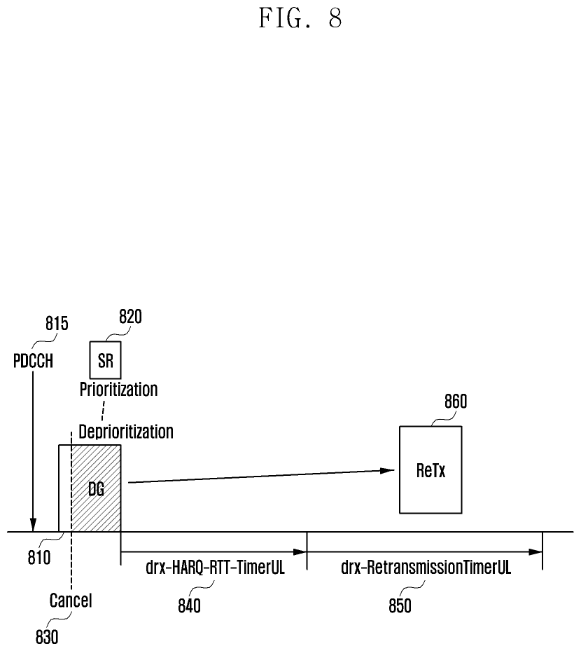

FIG. 8 is a diagram illustrating the operating mode of a DRX timer according to the deprioritization of a CG in an embodiment of the disclosure.

A dynamic grant (DG) is a one-time radio resource that a base station configures for a terminal as needed, and in uplink transmission, the terminal may identify the location of a corresponding uplink radio resource by a downlink control information (DCI) message of a PDCCH, and may perform transmission to the base station through the resource.

The embodiment of FIG. 8 illustrates a case in which a DG 810 is allocated for the terminal through a PDCCH 815 and is initially transmitted as a prioritized radio resource, but a high-priority scheduling request 820 subsequently occurs, and thus a scheduling request message is prioritized and the DG resource is deprioritized. In another embodiment, the DG resource may be deprioritized not only by the scheduling request but also by a CG resource overlapping on the time axis. Here, the transmission of the DG, which has already started, may be canceled due to the deprioritization of the DG (830).

Since the base station is able to identify that the transmission of the DG has started, the base station may allocate a retransmission resource for transmitting a MAC PDU of the CG that has been deprioritized and not transmitted to the terminal. In a case of a terminal in which DRX is configured, since the allocation of the retransmission resource is possible in the active time of the terminal, the extension of the active time may be required for the allocation of the retransmission resource. To this end, when the transmission of the DG is deprioritized and canceled by another radio resource (SR or another CG) before the transmission of the DG ends, that is, when the MAC PDU is partially transmitted, a MAC device of the terminal may start a drx-HARQ-RTT-TimerUL of a corresponding HARQ process in a first symbol after the end of a PUSCH resource for the transmission of the DG (840). When the transmission of the DG is a bundle transmission in which the same resource is transmitted in a plurality of DGs, the drx-HARQ-RTT-TimerUL of the HARQ process may be started in a first symbol after the end of a PUSCH resource for first transmission of the bundle. When the MAC PDU is not generated and thus the DG is not transmitted, if a retransmission resource is subsequently allocated, which is recognized as new transmission, a new MAC PDU may be generated and uplink-transmitted through the corresponding DG resource. Accordingly, in an embodiment, when the DG becomes a deprioritized uplink radio resource, the drx-HARQ-RTT-TimerUL may always be started. The embodiment of FIG. 8 shows that the drx-HARQ-RTT-TimerUL is started in the first symbol after the end of the PUSCH resource for the transmission of the DG regardless of whether the transmission of the DG is completed. Driving a drx-RetransmissionTimerUL of the HARQ process may be stopped in the first symbol after the end of the PUSCH resource for the transmission of the CG.

When the transmission of the DG is the bundle transmission in which the same resource is transmitted in the plurality of DGs, driving the drx-RetransmissionTimerUL of the HARQ process may be stopped in the first symbol after the end of the PUSCH resource for the first transmission of the bundle. When the drx-RetransmissionTimerUL is stopped, the active time of the terminal may be prevented from being unnecessarily extended, thereby reducing the power consumption of the terminal. The embodiment of FIG. 8 shows driving the drx-RetransmissionTimerUL is stopped in the first symbol after the end of the PUSCH resource for the transmission of the DG regardless of whether the transmission of the DG is completed. However, in another embodiment, a time point at which the drx-RetransmissionTimerUL is stopped may be a time point at which a first PUSCH for the DG is transmitted.

Subsequently, the MAC device of the terminal may start the drx-RetransmissionTimerUL at a time point at which the drx-HARQ-RTT-TimerUL stops driving (850). A time when the drx-RetransmissionTimerUL drives may become the active time, and in the active time, the terminal may perform PDCCH monitoring, and the base station may allocate the retransmission resource for the transmission of the DG previously deprioritized and not transmitted to the terminal (860). The base station may estimate the operating time of the drx-RetransmissionTimerUL of the terminal, and may allocate a radio resource through a PDCCH at the time.

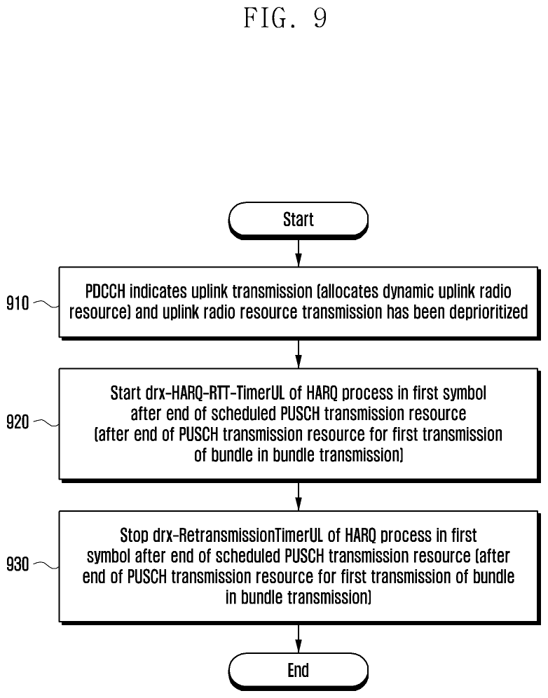

FIG. 9 is a flowchart illustrating the operating mode of a DRX timer according to the deprioritization of a CG in an embodiment of the disclosure.

In the embodiment of FIG. 9, it is assumed that a DG is deprioritized, which means that a PDCCH indicates uplink transmission and a radio resource for the uplink transmission is deprioritized (910). When the uplink radio resource is deprioritized, the transmission of the radio resource may not have started, or may have already started but been subsequently canceled.

In case that the DG is deprioritized, a drx-HARQ-RTT-TimerUL of a corresponding HARQ process may be started in a first symbol after the end of a scheduled PUSCH transmission resource (after the end of a PUSCH transmission resource for first transmission of a bundle in bundle transmission) (920). Operation 920 shows that the transmission of the DG is not completed, but the drx-HARQ-RTT-TimerUL is started in the first symbol after the end of the PUSCH resource for the transmission of the DG regardless of whether the transmission of the DG is completed. Starting the drx-HARQ-RTT-TimerUL may be for starting a drx-RetransmissionTimerUL after the expiration of this timer to allocate a retransmission resource for the DG deprioritized and not be transmitted.

In addition, the drx-RetransmissionTimerUL of the HARQ process may be stopped in the first symbol after the end of the scheduled PUSCH transmission resource (after the end of the PUSCH transmission resource for the first transmission of the bundle in the bundle transmission) (930), which may be for preventing the power consumption of the terminal due to the unnecessary extension of the active time.

In an embodiment, when a DG for new transmission is allocated and prioritized but a MAC PDU is not generated since a MAC PDU generation conditions is not satisfied, the drx-HARQ-RTT-TimerUL may not be started in operation 920. For example, a case of not satisfying the MAC PDU generation condition may correspond to a case in which padding is transmitted since there is no data to be included in a MAC PDU.

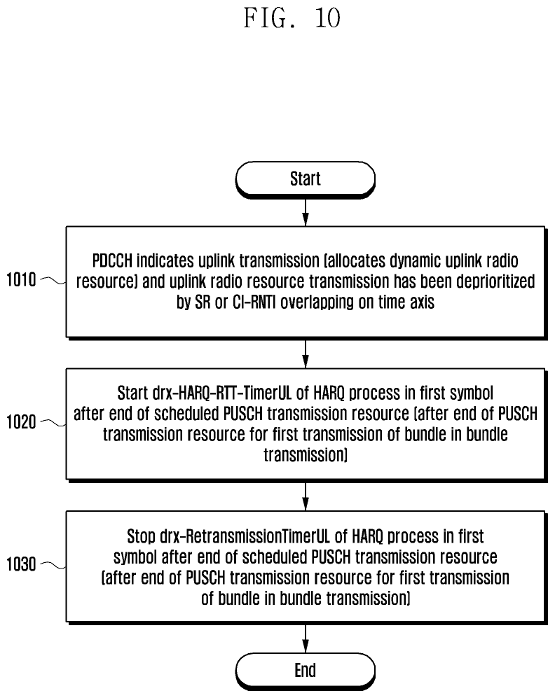

FIG. 10 is a flowchart illustrating the operating mode of a DRX timer according to the deprioritization of a CG in an embodiment of the disclosure.

In the embodiment of FIG. 10, it is assumed that a DG is deprioritized by an SR or a CI-RNTI, which means that a PDCCH indicates uplink transmission and an uplink radio resource is deprioritized by the SR overlapping on the time axis or is deprioritized due to cancellation of transmission thereof by the CI-RNTI (1010). When the uplink radio resource is deprioritized, the transmission of the radio resource may not have started, or may have already started but been subsequently canceled.

In case that the DG is deprioritized, a drx-HARQ-RTT-TimerUL of a corresponding HARQ process may be started in a first symbol after the end of a scheduled PUSCH transmission resource (after the end of a PUSCH transmission resource for first transmission of a bundle in bundle transmission) (1020). Operation 1020 shows that the transmission of the DG is not completed, but the drx-HARQ-RTT-TimerUL is started in the first symbol after the end of the PUSCH resource for the transmission of the DG regardless of whether the transmission of the DG is completed. Starting the drx-HARQ-RTT-TimerUL may be for starting a drx-RetransmissionTimerUL after the expiration of this timer to allocate a retransmission resource for the DG deprioritized and not be transmitted. In addition, the drx-RetransmissionTimerUL of the HARQ process may be stopped in the first symbol after the end of the scheduled PUSCH transmission resource (after the end of the PUSCH transmission resource for the first transmission of the bundle in the bundle transmission) (1030), which may be for preventing the power consumption of the terminal due to the unnecessary extension of the active time.

In an embodiment, when a DG for new transmission is allocated and prioritized but a MAC PDU is not generated since a MAC PDU generation conditions is not satisfied, the drx-HARQ-RTT-TimerUL may not be started in operation 1020. For example, a case of not satisfying the MAC PDU generation condition may correspond to a case in which padding is transmitted since there is no data to be included in a MAC PDU.

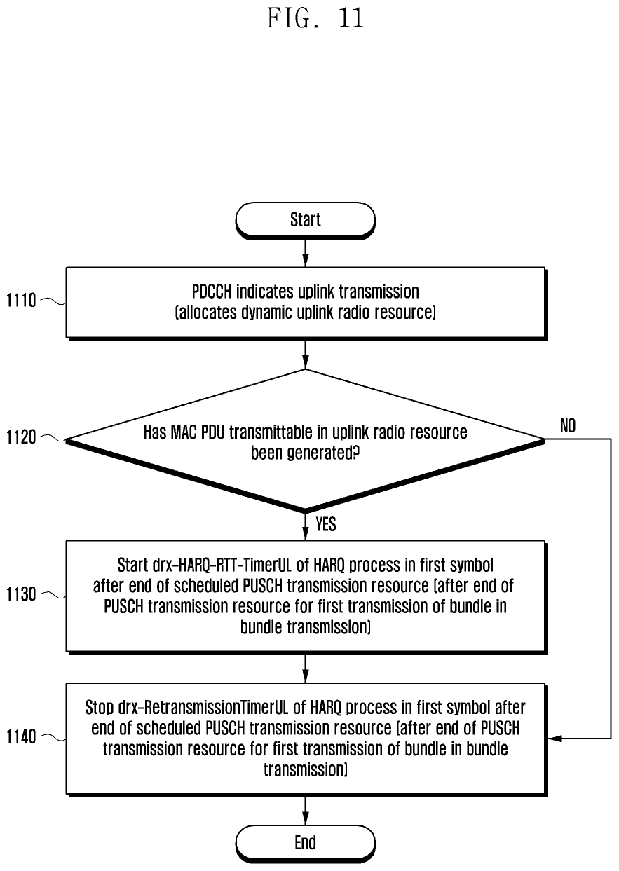

FIG. 11 is a flowchart illustrating the operating mode of a DRX timer according to the deprioritization of a CG in an embodiment of the disclosure.

In the embodiment of FIG. 11, it is assumed that an uplink resource of a DG is allocated, which means that a PDCCH indicates uplink transmission (1110).

Here, it may be identified whether a MAC PDU transmittable in the uplink radio resource is generated (1120). The MAC PDU being generated may mean that the uplink radio resource is a resource for retransmission and the MAC PDU to be transmitted is already stored in an HARQ buffer of a corresponding HARQ process, or may mean that the MAC PDU is obtained after the PDCCH indicates the uplink transmission. When the resource is initial transmission, the MAC PDU being generated may mean that the DG has been just prioritized and started to be initially transmitted.

When the MAC PDU transmittable in the uplink radio resource is generated in operation 1120, a drx-HARQ-RTT-TimerUL of a corresponding HARQ process may be started in a first symbol after the end of a scheduled PUSCH transmission resource (after the end of a PUSCH transmission resource for first transmission of a bundle in bundle transmission) (1130). Operation 1130 shows that the transmission of the DG is not completed, but the drx-HARQ-RTT-TimerUL is started in the first symbol after the end of the PUSCH resource for the transmission of the DG regardless of whether the transmission of the DG is completed. Starting the drx-HARQ-RTT-TimerUL may be for starting a drx-RetransmissionTimerUL after the expiration of this timer to allocate a retransmission resource for the DG deprioritized and not be transmitted. In addition, the drx-RetransmissionTimerUL of the HARQ process may be stopped in the first symbol after the end of the scheduled PUSCH transmission resource (after the end of the PUSCH transmission resource for the first transmission of the bundle in the bundle transmission) (1140), which may be for preventing the power consumption of the terminal due to the unnecessary extension of the active time.

If the MAC PDU transmittable in the uplink radio resource is not generated in operation 1120, driving the drx-RetransmissionTimerUL of the HARQ process may be stopped in the first symbol after the end of the scheduled PUSCH transmission resource (after the end of the PUSCH transmission resource for the first transmission of the bundle in the bundle transmission) (1140).

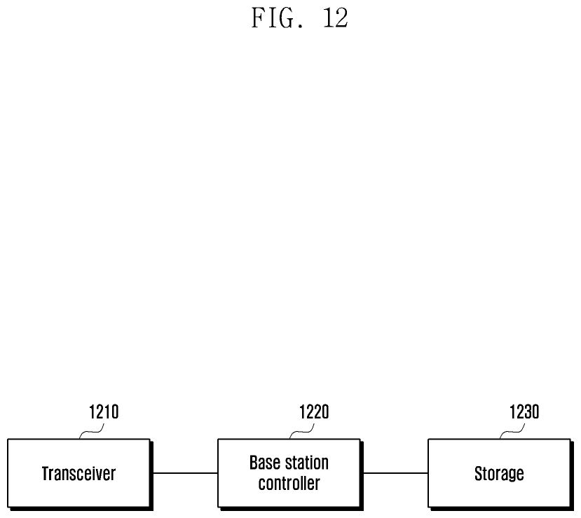

FIG. 12 is a diagram illustrating the structure of a base station according to an embodiment of the present invention.

With reference to FIG. 12, the base station may include a transceiver 1210, a controller 1220, and a storage 1230.

Herein, the controller 1220 may be defined as a circuit, an application-specific integrated circuit, or at least one processor. The transceiver 1210 may transmit and receive signals to and from another network entity. The transceiver 1210 may transmit system information, for example, to a terminal, and may transmit a synchronization signal or a reference signal. The controller 1220 may control the overall operation of the base station according to the embodiments proposed herein. For example, the controller 1220 may control signal flow between blocks to perform the operations according to the foregoing flowcharts. The storage 1230 may store at least one of information transmitted and received through the transceiver 1210 and information generated through the controller 1220.

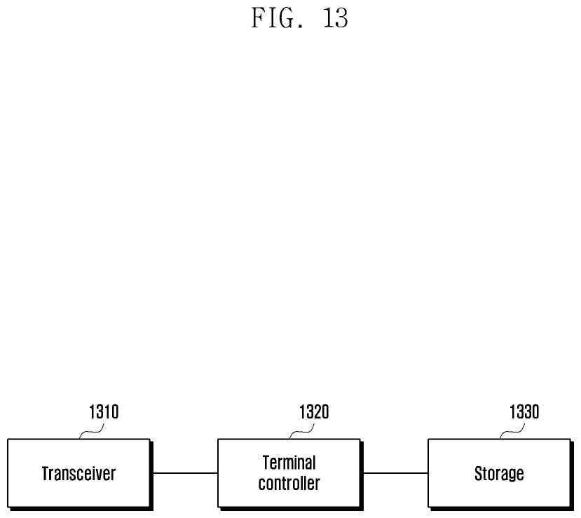

FIG. 13 is a diagram illustrating the structure of a terminal according to an embodiment of the present invention.

With reference to FIG. 13, the terminal may include a transceiver 1310, a controller 1320, and a storage 1330.

In the disclosure, the controller may be defined as a circuit, an application-specific integrated circuit, or at least one processor. The transceiver 1310 may transmit and receive signals to and from another network entity. The transceiver 1310 may receive system information, for example, from a base station, and may receive a synchronization signal or a reference signal. The controller 1320 may control the overall operation of the terminal according to the embodiments proposed in the disclosure. For example, the controller 1320 may control signal flow between blocks to perform the operations according to the foregoing flowcharts. The storage 1330 may store at least one of information transmitted and received through the transceiver 1310 and information generated through the controller 1320.

Although the detailed description of the present invention illustrates specific embodiments, various changes in form and detail may be made therein without departing from the scope of the present invention. Accordingly, the scope of the present invention should not be limited by the foregoing embodiments but be defined by the appended claims and equivalents thereto.

1. A method performed by a terminal in a wireless communication system, the method comprising:
performing a discontinuous reception (DRX) operation;
identifying an uplink grant for transmission;
identifying that the uplink grant is deprioritized, based on logical channel-based prioritization being configured; and
starting a hybrid automatic repeat request (HARQ) round-trip time (RTT) timer associated with to the DRX operation in a first symbol after end of a physical uplink shared channel (PUSCH) resource corresponding to the uplink grant, based on the uplink grant being de-prioritized.

2. The method of claim 1, further comprising:
identifying whether the HARQ RTT timer expires;
starting a retransmission timer associated with the DRX operation, based on an expiration of the HARQ RTT timer; and
monitoring a physical downlink control channel (PDCCH) allocating a retransmission resource for a deprioritized transmission in an active time by starting of the retransmission timer.

3. The method of claim 1, further comprising:
identifying whether a PUSCH transmission corresponding to a deprioritized transmission has already been initiated,
wherein the HARQ RTT timer is started in case that the PUSCH transmission has already been initiated.

4. The method of claim 3, further comprising
not starting the HARQ RTT timer in case that the PUSCH transmission has not already been initiated.

5. The method of claim 3, wherein, in case that the uplink grant is a configured grant (CG), the HARQ RTT timer is started based on an automatic transmission being not configured for the CG.

6. The method of claim 1, wherein, in case that the uplink grant is a configured grant (CG), the uplink grant is deprioritized, in case that a resource for the CG overlaps with at least one of a resource for a scheduling request (SR) having higher priority than the CG, a resource for another CG having higher priority than the CG, or a resource for a dynamic grant (DG) on a time axis or in case that a cancellation indication (CI)-radio network temporary identifier (RNTI) is received from a base station.

7. The method of claim 1, wherein, in case that the uplink is a dynamic grant (DG), the uplink grant is deprioritized in case that a resource for the DG overlaps with at a resource for a scheduling request (SR) having higher priority than the CG on a time axis or in case that a cancellation indication (CI)-radio network temporary identifier (RNTI) is received from a base station.

8. A terminal in a wireless communication system, the terminal comprising:
a transceiver; and
a controller configured to:
perform a discontinuous reception (DRX) operation,
identify an uplink grant for transmission, identify that the uplink grant is deprioritized, based on logical channel-based prioritization being configured, and start a hybrid automatic repeat request (HARQ) round-trip time (RTT) timer associated with to the DRX operation in a first symbol after end of a physical uplink shared channel (PUSCH) resource corresponding to the uplink grant, based on the uplink grant being de-prioritized.

9. The terminal of claim 8, wherein the controller is further configured to identify whether the HARQ RTT timer expires, start a retransmission timer associated with the DRX operation, based on an expiration of the HARQ RTT timer, and monitor a physical downlink control channel (PDCCH) allocating a retransmission resource for a deprioritized transmission in an active time by starting of the retransmission timer.

10. The terminal of claim 8,
wherein the controller is further configured to identify whether a PUSCH transmission corresponding to a deprioritized transmission has already been initiated, and
wherein the HARQ RTT timer is started in case that the PUSCH transmission has already been initiated.

11. The terminal of claim 10, wherein the controller is further configured not to start the HARQ RTT timer in case that the PUSCH transmission has not already been initiated.

12. The terminal of claim 10, wherein, in case that the uplink grant is a configured grant (CG), the HARQ RTT timer is started based on an automatic transmission being not configured for the CG.

13. The terminal of claim 8, wherein, in case that the uplink grant is a configured grant (CG), the uplink grant is deprioritized, in case that a resource for the CG overlaps with at least one of a resource for a scheduling request (SR) having higher priority than the CG, a resource for another CG having higher priority than the CG, or a resource for a dynamic grant (DG) on a time axis or in case that a cancellation indication (CI)-radio network temporary identifier (RNTI) is received from a base station.

14. The terminal of claim 8, wherein, in case that the uplink is a dynamic grant (DG), the uplink grant is deprioritized in case that a resource for the DG overlaps with at a resource for a scheduling request (SR) having higher priority than the CG on a time axis or in case that a cancellation indication (CI)-radio network temporary identifier (RNTI) is received from a base station.
